(19) United States
(12) Patent Application Publication
(10) Pub. No.: US 2015/0363091 A1
(43) Pub. Date: Dec. 17, 2015

(54) ELECTRONIC DEVICE AND METHOD OF CONTROLLING SAME

(71) Applicant: Samsung Electronics Co., Ltd., Suwon-si (KR)

(72) Inventors: Jang-Hoon LEE, Gumi-si (KR); Sung-Jun KIM, Daegu (KR)

(21) Appl. No.: 14/711,253

(22) Filed: May 13, 2015

(30) Foreign Application Priority Data
Jun. 12, 2014 (KR) 10-2014-0071392

(51) Int. Cl. G06F 3/0484; G06F 3/0481; G06T 11/60

(52) U.S. Cl. CPC G06F 3/04847; G06T 11/60; G06F 3/0481

(57) ABSTRACT

An electronic device is provided. The electronic device includes a display unit configured to display an image, a storage unit configured to store a subtitle display type corresponding to an input event related to the image, and a controller configured to detect the input event and to control to display subtitles according to the subtitle display type corresponding to the input event.

### CROSS-REFERENCE TO RELATED APPLICATION(S)

This application claims the benefit under 35 U.S.C. §119(a) of a Korean patent application filed on Jun. 12, 2014 in the Korean Intellectual Property Office and assigned Serial number 10-2014-0071392, the entire disclosure of which is hereby incorporated by reference.

### TECHNICAL FIELD

The present disclosure relates to an electronic device and a method of controlling the same. More particularly, the present disclosure relates to an apparatus and a method for effectively providing a content of an image when the image is reproduced.

### BACKGROUND

Technologies for electronic devices have been rapidly developing. For example, an electronic device can now reproduce various types of images.

However, when an image is reproduced in the electronic device, the image may include subtitles corresponding to the image. At this time, the subtitles may be displayed together with the image and provided to a user.

The user can understand the image through the subtitles even when the user cannot understand the language spoken in the image. Further, the subtitles may be provided in real time in accordance with a reproduction time of the image.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device and a method for reproducing an image in which a preset event is detected and to perform a preset subtitle displaying method corresponding to the preset event.

In accordance with an aspect of the present disclosure, an electronic device is provided. The electronic device includes a display unit configured to display an image, a storage unit configured to store a subtitle display type corresponding to an input event related to the image, and a controller configured to detect the input event and to control to display subtitles according to the subtitle display type corresponding to the input event.

In accordance with another aspect of the present disclosure, a method of controlling an electronic device is provided. The method includes displaying an image on a display unit of the electronic device, receiving an input event related to the displayed image, detecting the input event, and displaying subtitles corresponding to the image according to a subtitle display type corresponding to the input event.

According to various embodiments of the present disclosure, when an image sound is below a preset value, previously non-displayed subtitles start being displayed according to the subtitle display type and a user can continuously recognize a voice of a character regardless of a level of sound volume. Further, according to various embodiments of the present disclosure, when an image sound is above the preset value, currently displayed subtitles are be removed.

According to various embodiments of the present disclosure, one or more of a size, a brightness, and a color of the subtitles are changed through an adjustor that adjusts the sound volume of the image.

According to various embodiments of the present disclosure, when an image size change event of making a size of the image smaller than a preset size is detected, subtitles are displayed in a particular area outside the image, rather than inside the image. According to various embodiments of the present disclosure, when an image size change event of making the size of the image larger than the preset size is detected, the subtitles are displayed inside the image, rather than outside the image.

According to various embodiments of the present disclosure, in a display unit on which a plurality of images are reproduced, reproduction states of an active image and an inactive image, and subtitles and sounds of the images can be distinguished.

According to various embodiments of the present disclosure, the displaying of subtitles may be equally performed in real time in external electronic devices through a communication unit in accordance with a multi-screen event connected with the external electronic devices.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram schematically illustrating an electronic device which reproduces an image according to an embodiment of the present disclosure;

FIG. 2 is a flowchart illustrating an image reproduction method of reproducing an image according to a sound volume change event according to an embodiment of the present disclosure;

FIGS. 3A, 3B, 3C, 3D, 4A, 4B, 4C, 4D, 5A, 5B, and 5C schematically illustrate screens of an electronic device which reproduces an image according to various embodiments of the present disclosure;

FIG. 6 is a flowchart illustrating an image reproduction method according to an embodiment of the present disclosure;

FIGS. 7A, 7B, 7C, and 7D schematically illustrate screens of an electronic device which reproduces an image according to various embodiments of the present disclosure;

FIG. 8 is a flowchart illustrating a method of displaying subtitles in a plurality of images according to an embodiment of the present disclosure;

FIGS. 9A, 9B, and 9C schematically illustrate screens of an electronic device which reproduces an image according to various embodiments of the present disclosure;

FIG. 10 is a flowchart illustrating an image reproduction method according to an embodiment of the present disclosure;

FIGS. 11 and 12 schematically illustrate screens of an electronic device and an external device which work with each other according to various embodiments of the present disclosure;

FIGS. 13, 14A, 14B, 14C, 14D, and 14E are conceptual diagrams for describing an operation for playing and pausing an image displayed on each window according to a control of a window handler when an electronic device displays a plurality of windows according to various embodiments of the present disclosure; and

FIGS. 15A, 15B, and 15C are conceptual diagrams for describing an operation of displaying contents displayed on a screen of an external electronic device according to a selection of an image displayed in one window when an electronic device displays a plurality of windows according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Unless defined differently, all terms used herein, which include technical terminologies or scientific terminologies, have the same meaning as that understood by a person skilled in the art to which the present disclosure belongs. It should be interpreted that the terms, which are identical to those defined in general dictionaries, have the meaning identical to that in the context of the related technique. The terms should not be ideally or excessively interpreted as a formal meaning.

An electronic device that reproduces an image according to various embodiments of the present disclosure may correspond to an electronic device such as a personal computer, a mobile device, a smart phone, or a smart TV. However, although a mobile device will be described as an example of the electronic device hereinafter, the present disclosure is not limited thereto.

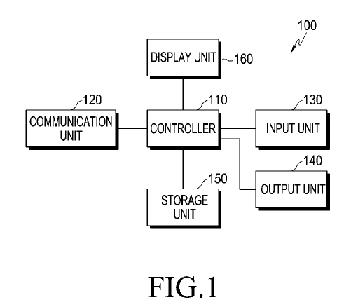

FIGS. 1 through 15C, discussed below, and the various embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the present disclosure. Terms first, second, and the like are used to differentiate between objects having the same terminology and are in no way intended to represent a chronological order, unless where explicitly stated otherwise. A set is defined as a non-empty set including at least one element.

FIG. 1 is a block diagram schematically illustrating an electronic device which reproduces an image according to an embodiment of the present disclosure.

Referring to FIG. 1, an electronic device 100, which reproduces an image according to an embodiment of the present disclosure, is illustrated, where the electronic device 100 may include a controller 110, a communication unit 120, an input unit 130, an output unit 140, a storage unit 150, and a display unit 160.

The controller 110 may include a Central Processing Unit (CPU), a Read-Only Memory (ROM) which stores a control program for controlling the apparatus 100, and a Random Access Memory (RAM) which stores signals or data input from the outside of the device 100, or is used as a storage region for operations performed by the device 100. The CPU may include a single core, a dual core, a triple core, and a quadruple core. The CPU, the RAM and the ROM may be connected with each other through internal buses. Further, the controller 110 may control the communication unit 120, the input unit 130, the output unit 140, or the storage unit 150.

The communication unit 120 connects the device 100 with an external device through mobile communication by using one or more antennas (not shown) under a control of the controller 110. The communication unit 120 may transmit/receive a wireless signal for a voice call, a video call, a Short Message Service (SMS), a Multimedia Message Service (MMS) or data to/from a mobile phone (not shown), a smart phone (not shown), a tablet PC, or another device (not shown) having a phone number input into the device 100.

The communication unit 120 may include at least one of a Wireless Local Area Module (WLAN) and a short-range communication module. The WLAN module may be connected to the Internet at a place where a wireless Access Point (AP) (not shown) is installed according to a control of the controller 110. The short-range communication module may wirelessly perform short-range communication between the device 100 and an image forming apparatus (not shown) according to a control of the controller 110. A short-range communication scheme may include a Bluetooth communication scheme, an Infrared Data Association (IrDA) communication scheme, a Wi-Fi Direct communication scheme, a Near Field Communication (NFC) scheme and the like.

The input unit 130 may include at least one of a plurality of buttons, a microphone, a vibration motor, a connector, and a keypad. The buttons may be formed on a front surface, a side surface, or a back surface of a housing of the device 100, and may include at least one of a power/lock button, a volume button, a menu button, a home button, a back button, and a search button. The microphone receives a voice or a sound and generates an electrical signal according to a control of the controller 110. The keypad may receive a key input from a user for a control of the device 100. The keypad includes a physical keypad (not shown) formed on the device 100 or a virtual keypad (not shown) displayed on the touch screen. The physical keypad (not shown) formed on the device 100 may be excluded according to the performance or structure of the device 100.

The output unit 140 may include a speaker. The speaker may output sounds corresponding to various signals (for example, a wireless signal, a broadcasting signal, a digital audio file, a digital video file, capturing a picture, and the like) to the outside of the device 100 according to a control of the controller 110. The speaker may output sounds (for example, a button operation sound or a ringtone corresponding to a voice call) corresponding to functions performed by the device 100. One or more speakers may be formed on a proper position or positions of the housing of the device 100.

The storage unit 150 may store input/output signals or data corresponding to operations of the communication unit 120, the input unit 130, the output unit 140, and the display unit 160 according to a control of the controller 110. The storage unit 150 may store a control program and applications for controlling the device 100 or the controller 110. The term “storage unit” may include the storage unit 150, the ROM and the RAM within the controller 110, or a memory card (not shown) (for example, an SD card or a memory stick) mounted to the device 100. The storage unit may include a non-volatile memory, a volatile memory, a Hard Disk Drive (HDD), and a Solid State Drive (SSD).

In the present disclosure, the display unit 160 may be implemented by a touch screen. Further, the touch is not limited to a contact between the touch screen 160 and the user's body or a touch input means and may include a non-contact touch. A distance of the non-contact detected by the touch screen 160 may be changed according to the performance or the structure of the device 100.

The touch screen 160, for example, may be implemented in a resistive type, a capacitive type, an infrared type, or an acoustic wave type.

A touch screen controller converts an analog signal received from the touch screen 160 to a digital signal (for example, X and Y coordinates) and transmits the converted digital signal to the controller 110. The controller 110 may control the touch screen 160 by using the digital signal received from the touch screen controller. For example, the controller 110 may cause a shortcut icon (not shown) displayed on the touch screen 160 to be selected or executed in response to the touch. Further, the touch screen controller may be included in the controller 110.

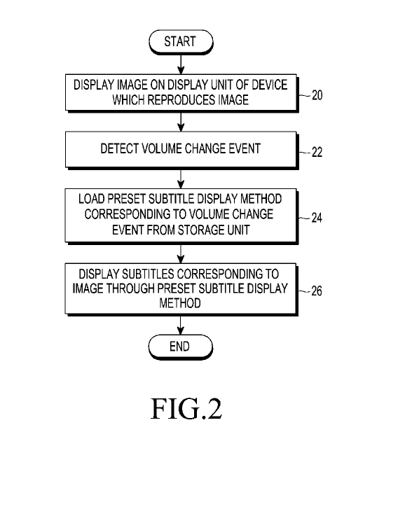

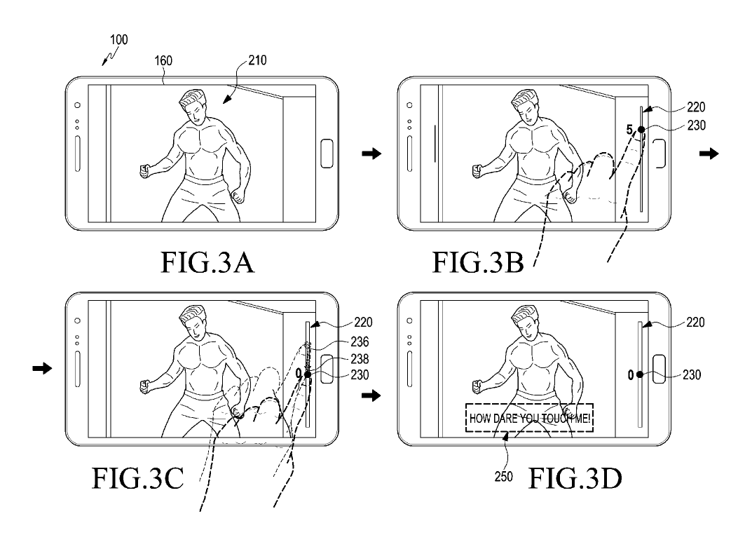

FIG. 2 is a flowchart illustrating an image reproduction method of reproducing an image according to a sound volume change event according to an embodiment of the present disclosure. FIGS. 3A, 3B, 3C, 3D, 4A, 4B, 4C, 4D, 5A, 5B and 5C schematically illustrate screens of an electronic device which reproduces an image according to various embodiments of the present disclosure.

Referring to FIGS. 2 to 5C, an image reproduction method according to a sound volume change event may first display an image on a display unit 160 of an electronic device 100, as illustrated for example in FIG. 3A, which reproduces an image. As illustrated in FIG. 2, in operation 20 the controller 110 of the electronic device 100 may reproduce the image on the display unit 160 by controlling the display unit 160. The image may include one or more images successively displayed. Further, the image may include sounds corresponding to the one or more images in real time. Accordingly, the controller 110 may reproduce the sounds through the speaker included in the output unit 140, as illustrated in FIG. 1.

For example, referring to FIG. 3A, an image 210 may be displayed on the display unit 160 of the electronic device 100. The image may include one or more images successively displayed. For example, the image may be a movie. At this time, the controller 110 may display the image of the movie on the display unit 160 and reproduce sounds of the movie through the output unit 140.

Next, a preset event (e.g., a volume change event) may be detected in operation 22, as illustrated in FIG. 2. The controller 110 of the electronic device 100 may detect the preset event.

In a first example according to the sound volume change with reference to FIGS. 3B and 3C, the volume change event may be an event of turning down the volume of the sound below a preset value using a control icon 230 on a control bar 220. Accordingly, when the controller 110 detects that the volume of the sound is smaller than the preset value, the controller 110 may detect generation of the volume change event.

For example, referring to FIG. 3B, the controller 110 may display a control bar 220 for controlling the volume of the sound. At this time, the volume of the sound may be increased or reduced by the control bar 220. For example, the display unit 160 may be implemented by the touch screen, and the controller 110 may detect the increase or reduction in the volume by detecting a movement of a control icon 230 of the control bar 220.

For example, the volume of FIG. 3B is 5. Referring to FIG. 3C, the controller 110 may detect a movement in a downward direction from a volume of 5 236 to a volume of 0 238 of the control icon 230. At this time, the preset value of the sound volume may be zero (state where there is no reproduction of sound). Accordingly, as illustrated in FIG. 3C, the controller 110 may detect an event of making the sound volume smaller than the preset value of 0.

Next, a preset subtitle display method corresponding to the preset event may be loaded from the storage unit 150 in operation 24, as illustrated in FIG. 2. The controller 110 of the electronic device 100 may load the preset subtitle display method corresponding to the preset event from the storage unit.

The preset subtitle display method corresponding to the preset event may be mapped and stored in the storage unit 150 in advance. Accordingly, when the controller 110 detects the preset event in operation 22, as illustrated in FIG. 2, the controller 110 may load the preset subtitle display method corresponding to the detected preset event from the storage unit 150.

For example, as illustrated in FIG. 3C, the volume change event may be the event of making the sound volume smaller than the preset value of 0. When the controller 110 detects the volume change event which is the event of turning down the sound volume below the preset value of 0, the controller 110 may load the preset subtitle display method corresponding to the present event from the storage unit 150. For example, the preset subtitle display method corresponding to the detected preset event may be a method of starting to display non-displayed subtitles. Accordingly, the controller 110 may load the method of starting to display the non-displayed subtitles.

Next, subtitles corresponding to the image may be displayed through the preset subtitle display method in operation 26, as illustrated in FIG. 2. The controller 110 of the electronic device 100 may display the subtitles corresponding to the image through the preset subtitle display method.

That is, when the preset subtitle display method corresponding to the volume change event is loaded in operation 24, the controller 110 may display the subtitles corresponding to the image through the preset subtitle display method corresponding to the volume change event.

For example, when the controller 110 loads the preset subtitle display method corresponding to the detected preset event as the method of starting to display the non-displayed subtitles in operation 24, the controller 110 may perform the method of starting to display the non-displayed subtitles. For example, as illustrated in FIG. 3D, the controller 110 may start displaying subtitles 250 which have not been displayed in FIG. 3C.

According to an embodiment of the present disclosure, when the event of turning down the sound volume below the preset value of 0 is detected, the non-displayed subtitles may start being displayed. That is, when sounds of the image are output, a voice spoken by a character of the image may be output and provided.

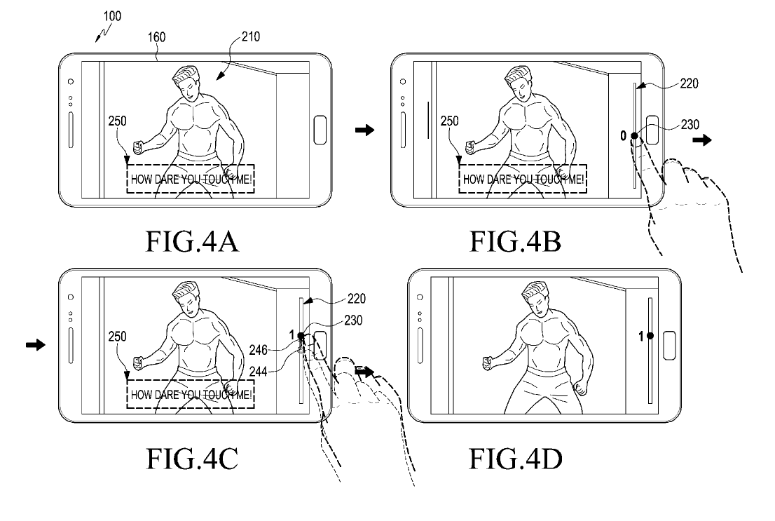

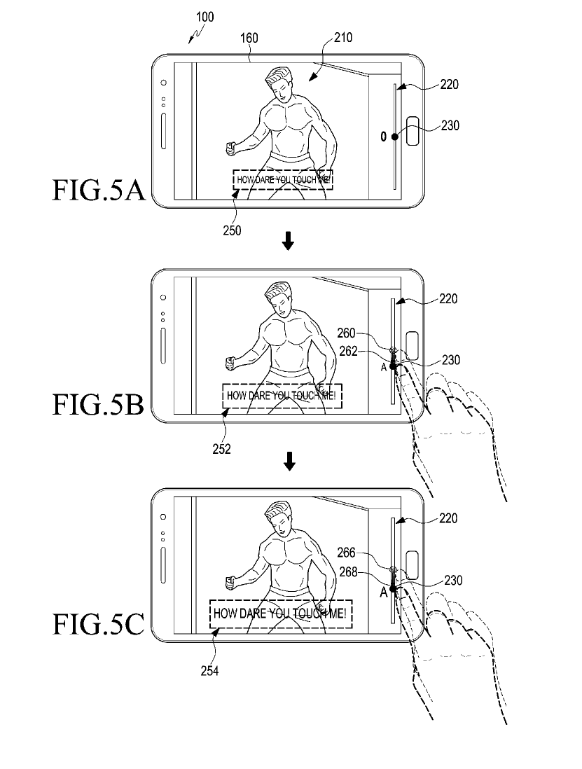

A second example according to the sound volume change will be described with reference to FIGS. 2, 4A, 4B, 4C and 4D. At this time, operation 20 of the second example is the same as that of the first example.

Next, a preset event may be detected in operation 22. The controller 110 of the electronic device 100 may detect the preset event. At this time, the volume change event may be an event of turning up the sound volume above a preset value. Accordingly, when the controller 110 detects that the sound volume is larger than the preset value, the controller 110 may detect generation of the volume change event.

For example, referring to FIG. 4A, an image 210 and subtitles 250 may be displayed on the display unit 160 of the electronic device 100. The image 210 may include one or more images successively displayed. For example, the image 210 may be a movie. At this time, the controller 110 may display the image of the movie on the display unit 160 and also display the subtitles 250 rather than reproducing sounds of the movie through the output unit 140.

For example, referring to FIG. 4B, the controller 110 may display a control bar 220 for controlling the sound volume. At this time, the sound volume may be increased or reduced by the control bar 220. For example, the display unit 160 may be implemented by the touch screen, and the controller 110 may detect the increase or reduction in the volume by detecting movement of a control icon 230 of the control bar 220.

For example, the volume of FIG. 4B is 0, such that the subtitles 250 are displayed. Referring to FIG. 4C, the controller 110 may detect a movement in an upward direction from the volume of 0 244 to a volume of 1 246 of the control icon 230 of the control bar 220. At this time, the preset value of the sound volume may be 0. Accordingly, as illustrated in FIG. 4C, the controller 110 may detect an event of turning up the sound volume above the preset value of 0.

Next, a preset subtitle display method corresponding to the preset event may be loaded from the storage unit in operation 24. The controller 110 of the electronic device 100 may load the preset subtitle display method corresponding to the preset event from the storage unit. At this time, the preset subtitle display method may be a method of removing the displayed subtitles.

For example, as illustrated in FIG. 4C, the volume change event may be the event of turning up the sound volume above the preset value of 0. When the controller 110 detects the volume change event which is the event of turning up the sound volume above the preset value of 0, the controller 110 may load the preset subtitle display method corresponding to the detected present event from the storage unit 150. For example, the preset subtitle display method corresponding to the preset event may be the method of removing the displayed subtitles 250 and the controller 110 may load the method of removing the displayed subtitles.

Alternatively, subtitles 250 corresponding to the image may be displayed through the preset subtitle display method in operation 26. The controller 110 of the electronic device 100 may display the subtitles corresponding to the image through the preset subtitle display method.

For example, when the controller 110 loads the preset subtitle display method corresponding to the detected preset event as the method of removing the displayed subtitles in operation 24, the controller 110 may perform the method of removing the displayed subtitles. For example, as illustrated in FIG. 4D, the controller 110 may remove subtitles 250 which have been displayed in FIG. 4C.

According to another embodiment of the present disclosure, when the event of turning up the sound volume above the preset value of 0 is detected, the displayed subtitles may be removed.

A third example according to the sound volume change event corresponding to an embodiment of the present disclosure will be described with reference to FIGS. 2, 5A, 5B, and 5C. In subtitles 250 of the third example, one or more of a size, a brightness, and a color may be changed through an adjustor that adjusts the sound volume. At this time, operations 20 to 24, as illustrated in FIG. 2, of the third example are the same as those of the first example described in FIG. 3A. Next, subtitles corresponding to the image may be displayed through the preset subtitle display method in operation 26. The controller 110 of the electronic device 100 may display the subtitles corresponding to the image through the preset subtitle display method.

For example, referring to FIG. 5A, an image 210 and subtitles 250 may be displayed on the display unit 160 of the electronic device 100. The image 210 may include one or more images successively displayed. For example, the image 210 may be a movie. At this time, the controller 110 may display the image of the movie on the display unit 160 and also display the subtitles 250 rather than reproducing sounds of the movie through the output unit 140.

Further for example, referring to FIG. 5A, the controller 110 may display a control bar 220 for controlling the sound volume. At this time, the sound volume may be increased or reduced by the control bar 220. For example, the display unit 160 may be implemented by the touch screen, and the controller 110 may detect the increase or reduction in the volume by detecting movement of a control icon 230 of the control bar 220.

For example, when the controller 110 loads the preset subtitle display method corresponding to the detected preset event as the method of starting to display the non-displayed subtitles in operation 24, the controller 110 may perform the method of starting to display the non-displayed subtitles. For example, referring to FIGS. 5A to 5C, a screen of FIG. 5A is the same as that of FIG. 3D. That is, as in the first example in FIG. 3D, the controller 110 may start displaying the subtitles 250 which have not been displayed in FIG. 3A. That is, also in the third example, the method of starting to display the non-displayed subtitles is performed in accordance with the event of turning down the sound volume the preset value, and thus the subtitles 250 may start being displayed as illustrated in FIG. 5A.

At this time, in the subtitles of the third example, one or more of a size, a brightness, and a color may be changed through an adjustor that adjusts the sound volume. For example, as illustrated in FIG. 5A, the adjustor that adjusts the sound volume may be formed by the control bar 220. At this time, one or more of the size, the brightness, and the color of the subtitles may be changed through the adjustor formed by the control bar.

Hereinafter, although an example in which the size of the subtitles 250 is changed through the adjustor will be described, the present disclosure is not limited thereto. For example, the display unit 160 may be implemented by the touch screen, and the controller 110 may detect a movement of the control icon 230 of the control bar 220. At this time, the controller 110 detects a movement in a downward direction of the control icon, and may make the size of the subtitles larger as the movement of the control icon 230 in the downward direction is longer.

Referring to FIG. 5B, the controller 110 may detect a first movement of the control icon 230 in a downward direction (from 260 to 262). Accordingly, the controller 110 may make the size of the subtitles 252 larger as the first movement of the control icon 230 in the downward direction (from 260 to 262) is longer. That is, the size of the subtitles 252 of FIG. 5B is larger than the size of the subtitles 250 of FIG. 5A.

Further, referring to FIG. 5C, the controller 110 may detect a second movement of the control icon 230 in a downward direction (from 266 to 268). Accordingly, the controller 110 may make the size of the subtitles 254 larger as the second movement of the control icon 230 in the downward direction (from 266 to 268) is longer. That is, the size of the subtitles 254 of FIG. 5C is larger than the size of the subtitles 252 of FIG. 5B. That is, the controller 110 may make the size of the subtitles larger as the movement of the control icon 230 in the downward direction is longer.

In the first movement of FIG. 5B, as a movement in a downward direction is longer by a second drag of FIG. 5C, the size of the subtitles may be gradually increased in the order of the subtitles 250 of FIG. 5A, the subtitles 252 of FIG. 5B, and the subtitles 254 of FIG. 5C. In contrast, as the controller 110 detects movement of the control icon in an upward direction and the movement of the control icon 230 in the upward direction is longer, the controller 100 may make the size of the subtitles smaller. Accordingly, the controller 110 may change the size of the subtitles to be larger or smaller according to a length of the drag in the downward or upward direction of the control icon 230. Further, the controller 110 may also change the brightness or color of the subtitles as well as the size of the subtitles.

According to another embodiment of the present disclosure, there is an advantage in that one or more of the size, the brightness, and the color of the subtitles can be changed through the adjustor that adjusts the sound volume of the image. That is, according to an embodiment of the present disclosure, when the sound of the image becomes smaller than a preset value, non-displayed subtitles start being displayed. Accordingly, the user can recognize a voice of a character. Continuously, one or more of the size, the brightness, and the color of the subtitles can be changed through an adjustor that adjusts the sound volume.

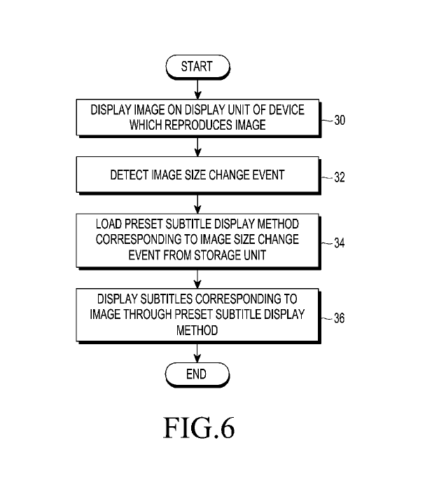

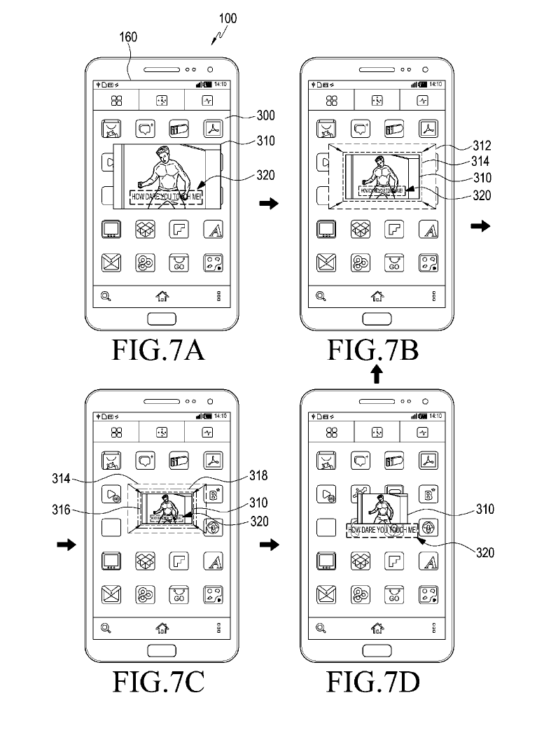

Various embodiments of the present disclosure will be described with reference to FIGS. 6 and 7.

FIG. 6 is a flowchart illustrating an image reproduction method according to an embodiment of the present disclosure. Further, FIGS. 7A, 7B, 7C and 7D schematically illustrate screens of an electronic device which reproduces an image according to various embodiments of the present disclosure.

Referring to FIG. 6, an image reproduction method according to an image size change event may first display an image on a display unit 160 of an electronic device 100, as illustrated for example in FIG. 1, which reproduces an image in operation 30. Since the description of operation 20 of FIG. 2 can be equally applied to operation 30, a detailed description of operation 30 will be omitted. Next, the image size change event may be detected in operation 32, as illustrated in FIG. 6. The controller 110 of the electronic device 100, as illustrated in FIG. 1, may detect the image size change event.

For example, the image size change event may be an event of making the image size smaller than a preset size. In contrast, the image size change event may be an event of making the image size larger than a preset size.

Accordingly, when the controller 110 detects that the sound volume is smaller than the preset value, the controller 110 may detect generation of the image size change event. In contrast, when the controller 110 detects that the sound volume is larger than the preset value, the controller 110 may detect generation of the image size change event.

For example, referring to FIG. 7A, the controller 110 may display the image on the display unit 160 in a pop-up form. The pop-up window may refer to an area (or window) popped up and displayed on the home screen (or background screen) with a size smaller than a home screen. The pop-up window may be displayed on a layer different from the home screen and the layer on which the pop-up window is displayed may be a layer located above the home screen. For example, as illustrated in FIG. 7A, the controller 110 may display the image such as a movie on a pop-up window 310 and display subtitles 320 above a home screen 300 displayed on the display 160 of the electronic device 100.

At this time, when the controller 110 detects that the image size is smaller than a preset value, the controller 110 may detect generation of the image size change event. For example, as illustrated in FIG. 7B, the controller 110 may detect that the size of the image 310 becomes smaller. The controller 110 may detect that the size of the image becomes smaller by detecting a touch for the image 310. The touch may be, for example, a pinch-out. The pinch-out may be simultaneous two touches which move closer to each other. At this time, when the pinch-out is detected, the controller 110 may adjust the size of the image as well as a size of the subtitles 320. For example, as illustrated in FIG. 7B, the controller 110 may make the size of the image smaller such that a first image size 312 becomes a second image size 314. Further, the controller 110 may detect the size of the image becomes smaller than a preset size.

For example, as illustrated in FIG. 7C, the controller 110 may detect that the size of the image becomes smaller from the second image size 314 to a third image size 316, for example, according to the detection of the pinch-out. At this time, the controller 110 may detect that the third image size 314 is smaller than a preset size 318. Accordingly, when the controller 110 detects that the third image size 316 is smaller than the preset size 318, the controller 110 may detect generation of the image size change event. At this time, the preset size 318 may refer to a minimum size which enables the subtitles 320 of the image 310 to be recognized by the user. That is, when the size of the image becomes smaller than the preset size 318, the subtitles 310 cannot be recognized by the user.

Referring to FIGS. 7A to 7C, since the subtitles 320 become smaller as the size of the image 310 becomes smaller, the size of the image 310 becomes smaller than the preset size 318. That is, as illustrated in FIG. 7C, the size of the subtitles 320 becomes small and thus cannot be recognized by the user. At this time, when the controller 110 detects that the image size is smaller than the preset value, the controller 110 may detect generation of the image size change event. Further, when the generation of the image size change event is detected, operation 34, as illustrated in FIG. 6, is performed.

In various embodiments of the present disclosure, a method of controlling the size of the image 310 may include not only the method of controlling the size of the image 310 by touching two or more positions of the image 310 through the pinch-out but also a method of controlling the size of the image 310 by touching one position of the image 310. Further, the size of the image 310 may be controlled through a menu (not shown) including a list of the size of the image 310. For example, the method of controlling the size of the image 310 may include at least one tap for the image 310. Further, the “touch” for controlling the size of the image 310 may include not only a direct touch on the touch screen 160 but also a proximity action for the touch screen 160 such as hovering. When various events for controlling the size of the image 310 is generated, the controller 110 may detect a change in the size of the image 310.

Next, a preset subtitle display method corresponding to the image size change event may be loaded from the storage unit 150, as illustrated for example in FIG. 1, in operation 34. The controller 110 of the electronic device 100 may load the preset subtitle display method corresponding to the image size change event from the storage unit.

At this time, the preset subtitle display method corresponding to the image size change event may be a method of displaying the subtitles displayed inside the image on a particular position outside the image.

Accordingly, the controller 110 may load the method of displaying the subtitle displayed inside the image on the particular position outside the image from the storage unit as the preset subtitle display method corresponding to the image size change event. Further, the controller 110 may load a method of displaying the subtitles with a size larger than a preset size on a position outside the image or displaying the subtitles on a preset position from the storage unit as the preset subtitle display method corresponding to the image size change event.

Next, subtitles corresponding to the image may be displayed through the preset subtitle display method in operation 36, as illustrated in FIG. 6. The controller 110 of the electronic device 100 may display the subtitles corresponding to the image through the preset subtitle display method.

For example, when the preset subtitle display method extracted in operation 34 is the method of displaying the subtitles displayed inside the image on the particular position outside the image, the controller 110 may perform the method of displaying the subtitles displayed inside the image on a position outside the image. That is, the controller 110 may display subtitles 320 displayed inside the image in FIG. 7C on a position outside the image as illustrated in FIG. 7D.

Further, the preset subtitle display method corresponding to the image size change event extracted in operation 34 may display the subtitles in a preset position outside the image to have a size larger than or equal to a preset size or display the subtitles in a preset position. That is, in FIG. 7D, the controller 110 may display the subtitles 320 with a size larger than that of the subtitles 320 displayed in FIG. 7C. Further, the subtitles 320 displayed in FIG. 7D may be displayed to be larger than a preset size. At this time, the preset size may be a minimum size with which the user can recognize the subtitles. When the subtitles are moved to the outside, a subtitle color and an effect may be expressed to be shown better to the user in comparison with a color of an outside background screen (for example, an application (App) icon color, an idle screen color or the like). Further, the controller 110 may display the subtitles 320 on a preset position in FIG. 7D. At this time, the preset position may be a lower portion of the image 310, but the present disclosure is not limited thereto.

According to another embodiment of the present disclosure, when the image size change event corresponding to an event of making the size of the image smaller than a preset size is detected, the preset subtitle display method corresponding to the method of displaying the subtitles displayed inside the image on a position outside the image may be performed. That is, when the subtitles become smaller as the size of the image becomes smaller, the subtitles may have a size which cannot be recognized by the user.

According to another embodiment of the present disclosure, when the subtitles become smaller and thus cannot be recognized by the user, the subtitles displayed inside the image may be displayed with a preset size or larger on a position outside the image. According to another embodiment of the present disclosure, there is an advantage in that the subtitles have the size which can be continuously recognized by the user even when the size of the image becomes smaller. Further, according to various embodiments of the present disclosure, when the subtitles become smaller and thus cannot be recognized by the user, the controller 110 may make a control to display the subtitles displayed inside the image on an external electronic device (not shown).

Accordingly, in order to display the subtitles on the external electronic device, the controller 110 may make a control to transmit subtitle data to the external electronic device. That is, according to various embodiments of the present disclosure, when the subtitles become smaller and thus cannot be recognized by the user, only the image may be displayed on the electronic device 100 and the subtitles may be displayed on the external electronic device.

In another example, in contrast to operation 32, the controller 110 may detect the image size change event corresponding to an event of making the size of the image larger than a preset size. For example, as illustrated in FIG. 7D, the controller 110 may detect that the size of the image 310 is larger than a preset size 318. At this time, when a pinch-in is detected, the controller 110 may make the size of the image larger.

For example, the controller 110 may enlarge the size of the image from a third image size 316 of FIG. 7D to a second image size 314 of FIG. 7B. Further, the controller 110 may detect that the size of the image is larger than the preset size 318. At this time, the preset size 318 may refer to a minimum size with which the user can recognize the subtitles 320 of the image 310. That is, when the size of the image becomes larger than the preset size 318, the subtitles 320 can be recognized by the user. Accordingly, when the controller 110 detects that the second image size 314 is larger than the preset size 318, the controller 110 may detect generation of the image size change event.

Next, in operation 34, the controller 110 may load the preset subtitle display method corresponding to the image size change event from the storage unit. For example, the preset subtitle display method may be a method of the subtitles displayed outside the image on a position inside the image.

Next, in operation 36, the controller 110 may perform the preset subtitle display method corresponding to the method of displaying the subtitles displayed outside the image on the position inside the image. For example, in FIG. 7D, the subtitles 320 displayed outside the image 310 may be displayed inside the image 310 as illustrated in FIG. 7B. According to another embodiment of the present disclosure, when the image size change event corresponding to an event of making the size of the image larger than the preset size is detected, the subtitles displayed outside the image may be displayed inside the image.

That is, according to another embodiment, when the size of the image becomes larger than the preset size, there is an advantage in that a screen other than the image, for example, a home screen, can be displayed outside the image by displaying the subtitles displayed outside the image on the position inside the image.

According to another embodiment of the present disclosure, when the size of the image becomes smaller than the preset size, there is an advantage in that the user can continuously recognize the subtitles by displaying the subtitles displayed inside the image on a particular position outside the image.

According to another embodiment of the present disclosure, when the size of the image becomes larger than the preset size, there is an advantage in that the subtitles displayed outside the image can be displayed back inside the image.

According to another embodiment of the present disclosure, when the size of the image becomes larger than the preset size, the controller 110 may make a control to display the subtitles displayed on the external electronic device (not shown) on a position inside the image.

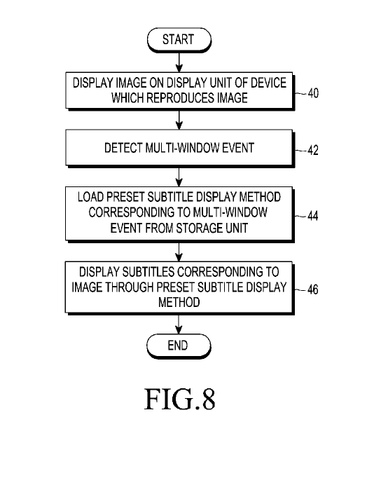

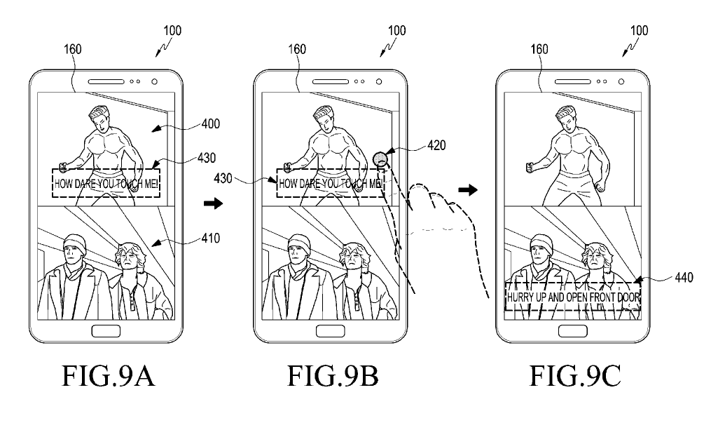

FIG. 8 is a flowchart illustrating a method of displaying subtitles in a plurality of images according to an embodiment of the present disclosure. FIGS. 9A, 9B, and 9C schematically illustrate screens of an electronic device which reproduces an image according to various embodiments of the present disclosure.

Referring to FIGS. 8 and 9A, a method of reproducing a plurality of images may first display an image on a display unit 160 of an electronic device 100 which reproduces an image in operation 40. The controller 110, as for example illustrated in FIG. 1, of the electronic device 100 may reproduce the image on the display unit 160 by controlling the display unit 160. Operation 40 is similar to operation 10 described in FIG. 2.

For example, referring to FIG. 9A, images 400 and 410 may be displayed on the display unit 160 of the electronic device 100. The image may include one or more images successively displayed. For example, the image may be a movie. At this time, the controller 110 may display the image of the movie on the display unit 160 and reproduce sounds of the movie through the output unit 140. Further, the image may be a plurality of images. For example, the controller 110 may display a plurality of movies corresponding to the plurality of images on the display unit 160. Referring to FIG. 9A, the controller 110 may display the first image 400 and the second image 410 corresponding to the plurality of movies on the display unit 160. At this time, the first image 400 and the second image 410 may be displayed with preset sizes within the display unit 160 and displayed on preset positions such as upper and lower portions. However, various embodiments of the present disclosure are not limited to the above method of displaying the plurality of images illustrated in FIG. 9A.

Next, a multi-window event may be detected in operation 42, as illustrated in FIG. 8. The controller 110 of the electronic device 100 may detect the multi-window event. At this time, the multi-window may be an event of displaying a plurality of images on the display unit together. Further, the multi-window event may be an event of activating one image among the plurality of images.

The event of activating one image among the plurality of images may select one image from the plurality of images. Further, the controller 110 may identify the selection by detecting an input for the one image among the plurality of images. Accordingly, when the controller 110 detects the input for the one image among the plurality of images, the controller 110 may detect the multi-window event corresponding to the event of activating the one image among the plurality of images.

For example, in FIG. 9A, the controller 110 may display the first image 400 and the second image 410 corresponding to the plurality of images on the display unit 160, where subtitles 430 are displayed on the first image 400.

Further, in FIG. 9B, the controller 110 may identify the selection by detecting an input for one image among the plurality of images. For example, the controller 110 may detect an input 420 for the first image 400. Further, when the controller 110 detects the input 420 for the first image 400, the controller 110 may detect the multi-window event corresponding to the event of activating the first image 400.

Next, a preset subtitle display method corresponding to the multi-window event may be loaded from the storage unit in operation 44, as illustrated in FIG. 8. The controller 110 of the electronic device 100 may load the preset subtitle display method corresponding to the multi-window event from the storage unit. For example, the preset subtitle display method corresponding to the multi-window event may be a method of removing subtitles of the active image, reproducing sounds of the active image, displaying subtitles of the inactive image, and removing sounds of the inactive image.

For example, in FIG. 9B, when the controller 110 detects the multi-window event corresponding to the event of activating the first image 400, the controller 110 may load the preset subtitle display method corresponding to the multi-window event. At this time, the controller 110 may load the preset subtitle display method corresponding to the method of removing subtitles of the active image, reproducing sounds of the active image, displaying subtitles of the inactive image, and removing sounds of the inactive image.

Next, subtitles corresponding to the image may be displayed through the preset subtitle display method in operation 46, as illustrated in FIG. 8. The controller 110 of the electronic device 100 may display the subtitles corresponding to the image through the preset subtitle display method.

That is, when the preset subtitle display method corresponding to the multi-window event is loaded in operation 44, the controller 110 may display the subtitles corresponding to the image through the preset subtitle display method corresponding to the multi-window event.

For example, when the controller 110 loads the method of removing subtitles of the active image, reproducing sounds of the active image, displaying subtitles of the inactive image, and removing sounds of the inactive image as the preset subtitle display method corresponding to the detected preset event in operation 44, the controller 110 may perform the preset subtitle display method. For example, the controller 110 may remove the subtitles of the active image, reproduce the sounds of the active image, display the subtitles of the inactive image, and remove the sounds of the inactive image.

For example, when the active image is the first image 400 in FIG. 9B, the controller 110 may remove subtitles 420 of the first image 400 and reproduce sounds of the first image 400 as illustrated in FIG. 9C. Further, the controller 110 may display subtitles 440 of the inactive second image 410 and remove sounds of the second image 410. That is, the controller 110 may remove the subtitles of the active image, reproduce the sounds of the active image, display the subtitles of the inactive image, and remove the sounds of the inactive image at the same time.

According to an embodiment of the present disclosure, in a display unit on which a plurality of images are reproduced, subtitles and sounds of an active image and an inactive image can be distinguished. That is, in an embodiment of the present disclosure, a sound of the active image is reproduced and provided in order for the user to immediately recognize a voice of a character in the image, but subtitles of the inactive image are provided in order for the user to also view the subtitles with their eyes. Accordingly, the user can immediately recognize the voice of the character in the active image through the sound and recognize the voice of the character in the inactive image through the subtitles.

Therefore, when multiple windows in which a plurality of images are reproduced are displayed, an embodiment of the present disclosure may provide voices of characters in the plurality of images through both the sound and the subtitles. That is, an embodiment of the present disclosure has an advantage in that the voices of the characters in the plurality of images can be simultaneously recognized by the user when the multiple windows are reproduced.

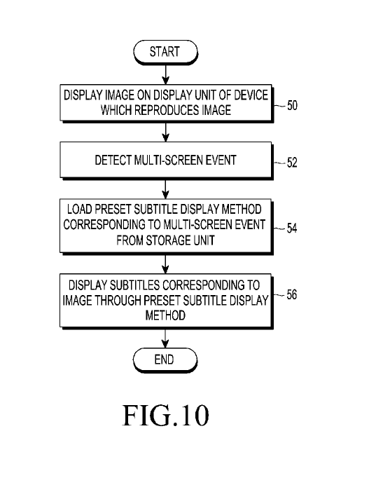

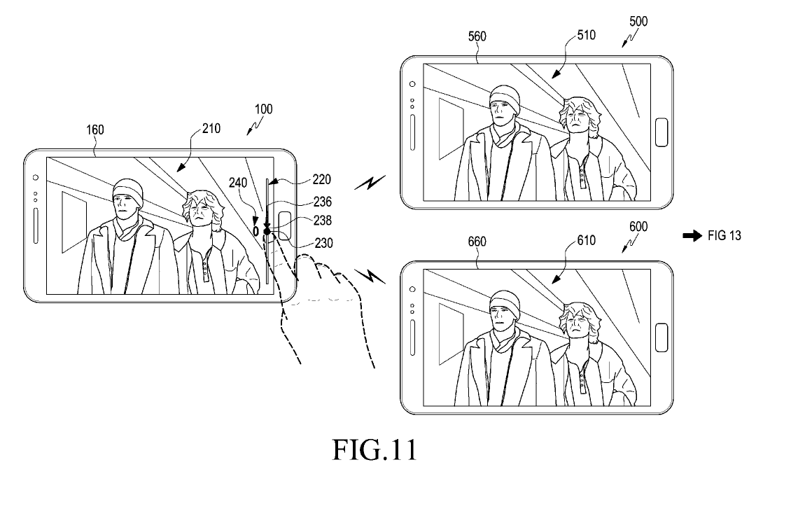

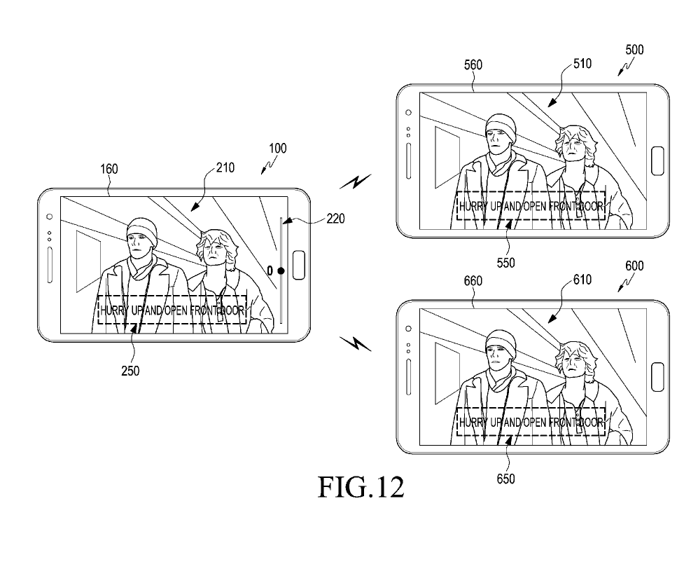

FIG. 10 is a flowchart illustrating an image reproduction method according to an embodiment of the present disclosure. FIGS. 11 and 12 schematically illustrate screens of an electronic device and an external device which work with each other according to various embodiments of the present disclosure.

Referring to FIGS. 10 to 12, an image reproduction method according to an embodiment of the present disclosure may first display an image on a display unit 160 of an electronic device 100 which reproduces an image in operation 50. The controller 110 of the electronic device may reproduce the image on the display unit 160 by controlling the display unit 160. Operation 50 may be the same as operation 20 described in FIG. 2. For example, referring to FIG. 11, an image 210 may be displayed on the display unit 160 of the electronic device 100. The image may include one or more images successively displayed. For example, the image may be a movie. At this time, the controller 110 may display the image of the movie on the display unit 160 and reproduce sounds of the movie through the output unit 140, as illustrated in FIG. 1.

Next, a multi-screen event may be detected in operation 52, as illustrated in FIG. 10. The controller 110 of the electronic device 100 may detect the multi-screen event. The multi-screen event may be an event of connecting to an external electronic device through a communication unit over the network.

The electronic device which reproduces the image according to an embodiment of the present disclosure and the external electronic device may correspond to electronic devices, for example, a personal computer, a mobile device, a smart phone, or a smart TV. However, various embodiments of the present disclosure are not limited to the above lists of the electronic device.

Further, the electronic device which reproduces the image according to an embodiment of the present disclosure may be connected to the external electronic device through the communication unit 120, as illustrated in FIG. 1. The communication unit 120 may connect the electronic device 100 to the external electronic device through mobile communication by using one or more antennas (not shown) according to a control of the controller 110. The electronic device 100 which reproduces the image may transmit/receive a wireless signal for a voice call, a video call, an SMS, an MMS, or data to/from the external electronic device through the communication unit 120. Accordingly, the controller 110 of the electronic device 100 which reproduces the image may detect the connection with the external electronic device through the communication unit over the network. Further, when the connection with the external electronic device through the communication unit over the network is detected, the controller 110 may detect the multi-screen event.

Referring to FIG. 11, for example, the electronic device 100 which reproduces the image according to an embodiment of the present disclosure may be connected to the external electronic device through the communication unit 120 over the network. Further, there may be multiple external electronic devices. For example, as illustrated in FIG. 11, the external electronic device may be a first external electronic device 500 and a second external electronic device 600. Accordingly, the controller 110 of the electronic device 100 which reproduces the image may detect the multi-screen event when connections with the external electronic devices 500 and 600 are detected through the connection unit over the network.

At this time, data about the image displayed on the electronic device 100 which reproduces the image may be transmitted in real time to the external electronic devices 500 and 600. Further, the controller of the external electronic devices 500 and 600 may make a control to display the received images 510 and 610 on display units 560 and 660. In addition, the controller of the external electronic devices 500 and 600 may store the received image in storage units.

Next, a preset subtitle display method corresponding to the multi-screen event may be loaded from the storage unit in operation 54, as illustrated in FIG. 10. The controller 110 of the electronic device 100 may load the preset subtitle display method corresponding to the multi-screen event from the storage unit. For example, the preset subtitle display method corresponding to the multi-screen event may be a method of equally displaying the subtitles on the external electronic devices in real time through the communication unit.

For example, as illustrated in FIG. 11, the controller 110 of the electronic device 100 which reproduces the image may load the preset subtitle display method corresponding to the multi-screen event when the multi-screen event corresponding to connections with the external electronic devices 500 and 600 through the communication over the network is detected. At this time, the controller 110 may load the preset subtitle display method corresponding to the method of equally displaying the subtitles on the external electronic devices through the communication unit.

Next, subtitles corresponding to the image may be displayed through the preset subtitle display method in operation 56, as illustrated in FIG. 10. The controller 110 of the electronic device 100 may display the subtitles corresponding to the image through the preset subtitle display method.

That is, when the preset subtitle display method corresponding to the multi-screen event is loaded in operation 54, the controller 110 may display the subtitles corresponding to the image through the preset subtitle display method corresponding to the multi-screen event. For example, the preset subtitle display method may be a method of equally displaying the subtitles on the external electronic devices in real time through the communication unit 120.

Accordingly, the controller 110 of the device which reproduces the image makes a control to perform the method of equally displaying the subtitles on the external electronic devices 500 and 600 in real time through the communication unit 120. At this time, the method of displaying the subtitles may be the method described in FIGS. 2 to 9C. For example, the method of displaying the subtitles may be the preset subtitle display method corresponding to the volume change event, the image size change event, or the multi-window event.

In the example illustrated in FIGS. 11 and 12, the preset subtitle display method corresponding to the volume change event is equally performed in real time in the external electronic devices 500 and 600 through the communication unit 120.

For example, referring to FIG. 11, the controller 110 of the electronic device 100 which reproduces the image may perform a method of starting to display non-displayed subtitles in accordance with the volume change event corresponding to the event of turning down the sound volume below a preset value. The controller 110 may detect a movement (from a position 236 to a position 238) of a control icon 230 of a control bar 220 and start displaying the non-displayed subtitles in accordance with the event of turning down the sound volume below a preset value, for example, 0.

That is, the controller 110 may start displaying the subtitles 250 as illustrated in FIG. 12. At this time, the controller 110 may equally perform the method of displaying the non-displayed subtitles in real time in the external electronic devices 500 and 600. That is, the controller 110 may start displaying, along with images 510 and 610, non-displayed subtitles 550 and 650 on the display units 560 and 660 in the external electronic devices 500 and 600, respectively, as illustrated in FIG. 12.

According to another embodiment of the present disclosure, the method of displaying the subtitles may be equally performed in real time in the external electronic devices through the communication unit in accordance with the multi-screen event connected with the external electronic devices through the communication unit over the network. As illustrated in FIGS. 11 and 12, when the non-displayed subtitles start being displayed in the device which reproduces the image, the non-displayed subtitles may start being equally displayed in the external electronic devices in real time. That is, according to another embodiment of the present disclosure, when the method of displaying the subtitles in the device which reproduces the image is changed, the method may be equally changed in the external electronic devices in real time.

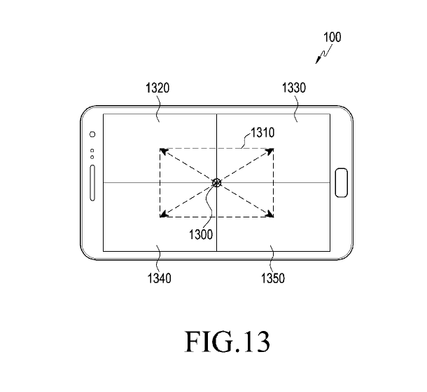

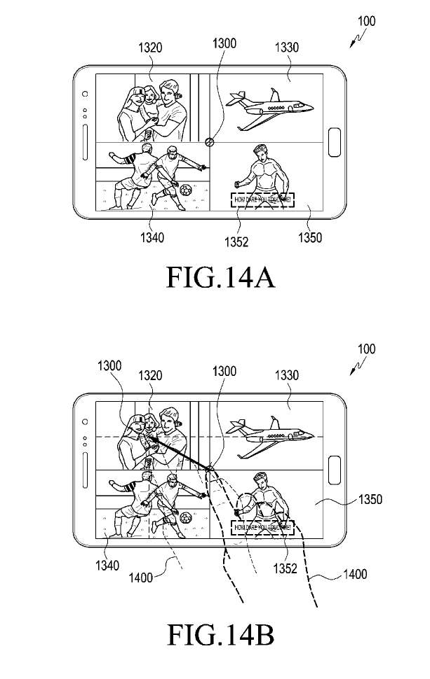

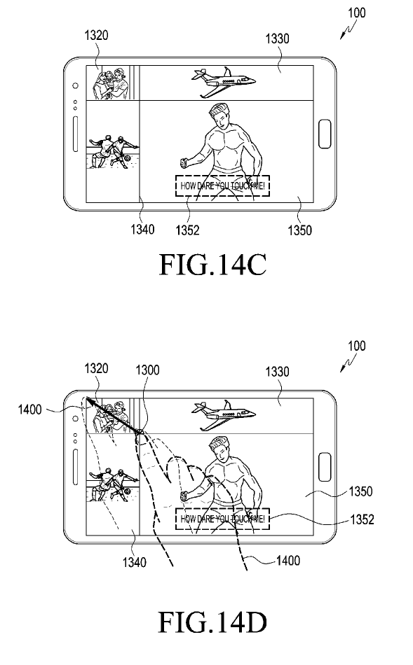

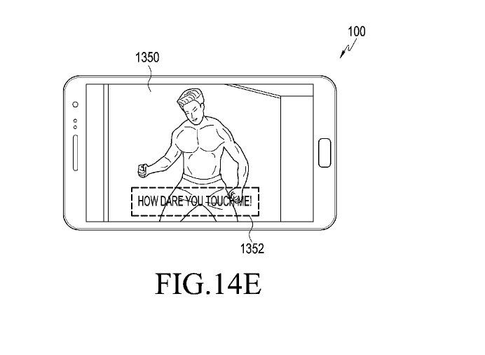

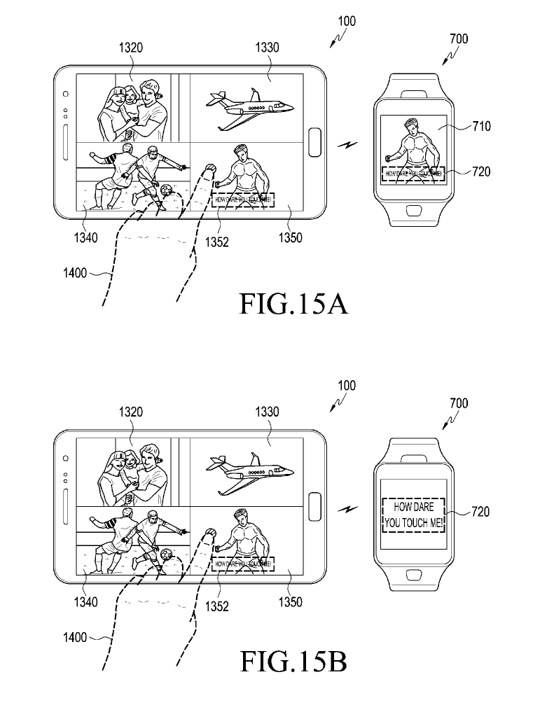

FIGS. 13, 14A, 14B, 14C, 14D and 14E are conceptual diagrams for describing an operation for playing and pausing an image displayed on each window according to a control of a window handler when an electronic device displays a plurality of windows according to various embodiments of the present disclosure.

Referring to FIG. 13, an electronic device 100 may include a plurality of windows 1320, 1330, 1340, and 1350 to display a plurality of screens on the touch screen 160, as illustrated in FIG. 1. A preset screen or a screen selected by the user may be displayed in each of the windows 1320, 1330, 1340, and 1350. For convenience of description, although the plurality of windows 1320, 1330, 1340, and 1350 are four in FIG. 13, the number of windows 1320, 1330, 1340, and 1350 is not limited thereto. The number of windows 1320, 1330, 1340, and 1350 may be variously changed during a manufacturing process of the electronic device 100 according to an embodiment of the present disclosure or according to the user's selection.

The user may control sizes of the windows 1320, 1330, 1340, and 1350 by controlling a window handler 1300. When a size of one or more areas of the windows 1320, 1330, 1340, and 1350 exceeds a predetermined threshold, the controller 110, as illustrated in FIG. 1, according to an embodiment of the present disclosure may make a control to reproduce only an image having a size exceeding the threshold. For example, whether a size of one or more areas exceeds the predetermined threshold may be determined based on a position of the window handler 1300 as illustrated in FIG. 13. That is, the controller 110 may determine whether the position of the window handler 1300 is located within a threshold area formed by threshold points 1310 or beyond the threshold area.

When the window handler 1300 is located within the threshold area, the controller 110 may maintain a playing state without stopping images displayed on the plurality of windows 1320, 1330, 1340, and 1350. However, when the window handler 1300 is located beyond any of the threshold points 1310 and thus escapes from the threshold area, the controller 110 may make a control to reproduce only images displayed on one or more windows having the largest size according to a control of the window handler 1300. These features will be described in more detail with reference to FIGS. 14A to 14E.

Referring to FIG. 14A, various images may be displayed in the plurality of windows 1320, 1330, 1340, and 1350 that are displayed on an electronic device 100. The various images may be dynamic images or still images. For convenience of description, it will be described as an example that the images displayed in the plurality of windows 1320, 1330, 1340, and 1350 are dynamic images. Further, it is assumed that the images displayed in the plurality of windows 1320, 1330, 1340, and 1350 are being currently reproduced.

Referring to FIG. 14B, a user 1400 may enlarge one window (for example, window 1350) by controlling a window handler 1300. The control of the window handler 1300 by the user 1400 may be a touch or hovering for the window handler 1300. According to a control of the window handler 1300 illustrated in FIG. 14B, one window (for example, window 1350) may be switched to a state illustrated in FIG. 14B where the window is more enlarged in comparison with a state illustrated in FIG. 14A. FIG. 14C illustrates a case where the window handler 1300 goes beyond the threshold area defined by the threshold point 1310, as illustrated in FIG. 13, according to the control of the window handler 1300 as illustrated in FIG. 14B, that is, a case where a size of one window exceeds a threshold size.

Accordingly, the controller 110 may make a control to reproduce only a dynamic image displayed on the window 1350 having the size exceeding the threshold size. Further, the controller 110 may make a control to stop dynamic images displayed in the other areas 1320, 1330, and 1340. When the position of the window handler 1300 does not exceed the threshold point 1310 in a process of controlling the window handler 1300 as illustrated in FIG. 14B, that is, when sizes of one or more windows do not exceed the threshold size, the controller 110 may maintain a current state where the images displayed in the plurality of windows 1320, 1330, 1340, and 1350 are reproduced.

The user 1400 may control the window handler 1300 to switch one window 1350 having the size exceeding the threshold size to a full screen, as illustrated in FIG. 14E. According to the control of the window handler 1300, the one window 1350 having the size exceeding the threshold size may be switched to the full screen as illustrated in FIG. 14E. Further, when subtitles are displayed together with the image, the subtitles 1352 may be also displayed.

Although only one window (for example, window 1350) exceeds the threshold size in FIGS. 14A to 14E, embodiments of the present disclosure are not limited thereto. For example, when the user moves the window handler 1300 in a vertical direction, that is, downwardly or upwardly moves the window handler 1300 in a state illustrated in FIG. 13, two windows (for example, windows 1320 and 1330 when the window handler 1300 is downwardly moved) may have the same size and exceed the threshold size. Accordingly, in this case, the controller 110 may make a control to reproduce only images which are being reproduced in the windows 1320 and 1330 having the size exceeding the threshold size.

Further, although it has been described that all the dynamic images are reproduced in the plurality of windows 1320, 1330, 1340, and 1350 for convenience of description, embodiments of the present disclosure are not limited thereto. The dynamic image may be reproduced in one area (for example, the window 1320) and still images may be displayed in the other areas (for example, the windows 1330, 1340, and 1350). As described above, the description made in FIGS. 13 to 14E may be equally applied to a case where different types of images are displayed together. However, it is difficult to apply the concept “reproduction” to the still image. Accordingly, the description made in FIGS. 13 to 14E may be applied only to dynamic images which are being reproduced or paused.

Further, the description related to FIGS. 14A to 14E can be inversely applied. For example, when the window (for example, window 1350) having the size exceeding the threshold size is reduced to have a size smaller than or equal to the threshold size through a control of the window handler 1300 in the state illustrated in FIG. 14E, the controller 110 may make a control to again reproduce dynamic images (for example, the dynamic images displayed in the windows 1320, 1330, and 1340) which are paused, from a pause time point. According to an embodiment of the present disclosure, the reproduction or pause of the images displayed in the window 1320, 1330, 1340, and 1350 can be controlled by the control of the window handler 1300 alone. Therefore, there is an effect in that the user convenience can be improved.

A determination on whether one or more window sizes exceed the threshold size based on the position of the window handler 1300 as illustrated in FIG. 13 is only an example for the description of the present disclosure. The controller may determine whether one or more window sizes exceed the threshold size by directly calculating the sizes of the windows 1320, 1330, 1340, and 1350 which are changed according to the control of the window handler 1300 in addition to the method described in FIG. 13.

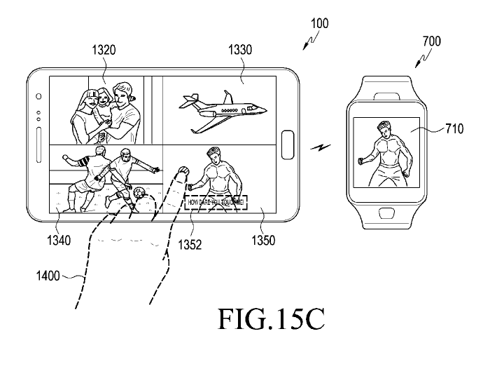

FIGS. 15A, 15B and 15C are conceptual diagrams for describing an operation of displaying contents displayed on a screen of an external electronic device according to a selection of an image displayed in one window when an electronic device displays a plurality of windows according to various embodiments of the present disclosure.

Referring to FIG. 15A, when images and subtitles are displayed on a plurality of windows 1320, 1330, 1340, and 1350, a user 1400 may select only an image displayed in one window (for example, the window 1350). The selection may be made through a touch or hovering on a touch screen 160, as illustrated for example in FIG. 1, of an electronic device 100 by the user 1400.

When a selection input for one window is received from the user, the controller 110, as illustrated in FIG. 1, may make a control to transmit data about an image and subtitles 1352 displayed in the selected window (for example, the window 1350) to an external electronic device 700 (for example, “Galaxy gear”) in order to display the image and subtitles 1352 on the external electronic device 700. Accordingly, the communication unit 120, as illustrated in FIG. 1, may transmit the data about the image and subtitles displayed on the selected window (for example, the window 1350) to the external electronic device 700. The external electronic device 700 may display an image 710 and subtitles 720 on the display unit of the external electronic device 700 based on the received data about the image and subtitles.

According to various embodiments of the present disclosure, in order to display only subtitles 1352 for the selected image on the external electronic device 700 as illustrated in FIG. 15B, the controller 110 may make a control to transmit only the data about the subtitles to the external electronic device 700. Accordingly, the communication unit 120 may transmit only the data about the subtitles to the external electronic device 700. The external electronic device 700 may display only the subtitles 720 based on the received data for the image.

Further, according to various embodiments of the present disclosure, as illustrated in FIG. 15C, when a selected image includes subtitles 1352, the controller 110, as illustrated in FIG. 1, may make a control to transmit only data about an image displayed in a selected window (for example, window 1350 of windows 1320, 1330, 1340 and 1350) to an external electronic device 700 in order to display the image on the external electronic device 700. Accordingly, the communication unit 120, as illustrated in FIG. 1, may transmit only the data about the image to the external electronic device 700. The external electronic device 700 may display only an image 710 based on the received data for the image.

The external electronic device 700 may include a separate controller (for example, a processor) for controlling the external electronic device 700. Alternatively, the external electronic device 700 may be controlled by the controller 110 of the electronic device 100 according to an embodiment of the present disclosure without a separate controller (not shown). When the external electronic device 700 is controlled by the controller 110 of the electronic device 100, the operations performed by the external electronic device 700 may be controlled by the controller 110 of the electronic device 100.

Further, although the smart watch (for example, “Galaxy gear”) has been described as an embodiment of the external electronic device 700 in FIGS. 15A to 15C, embodiments of the external electronic device 700 are not limited thereto. The external electronic device 700 may include at least one of a smart phone, a tablet Personal Computer (PC), a mobile phone, a video phone, an electronic book reader (e-book reader), a laptop PC, a netbook computer, a Personal Digital Assistant (PDA), a Portable Multimedia Player (PMP), a MPEG-1 audio layer-3 (MP3) player, a mobile medical device, a camera, and various wearable devices.

It will be appreciated that the various embodiments of the present disclosure may be implemented in a form of hardware, software, or a combination of hardware and software. Any such software may be stored, for example, in a volatile or non-volatile storage device such as a ROM, a memory such as a RAM, a memory chip, a memory device, or a memory IC, or a recordable optical or magnetic medium such as a CD, a DVD, a magnetic disk, or a magnetic tape, regardless of its ability to be erased or its ability to be re-recorded. A web widget manufacturing method of the present disclosure can be realized by a computer or a portable terminal including a controller and a memory, and it can be seen that the memory corresponds to an example of the storage medium which is suitable for storing a program or programs including instructions by which the embodiments of the present disclosure are realized, and is machine readable. Accordingly, the present disclosure includes a program for a code implementing the apparatus and method described in the appended claims of the specification and a machine (a computer or the like)-readable storage medium for storing the program. Further, the program may be electronically transferred by a predetermined medium such as a communication signal transferred through a wired or wireless connection, and the present disclosure appropriately includes equivalents of the program.

In addition, the above-described electronic apparatus may receive and store the program from a program supply apparatus wiredly or wirelessly connected thereto. The program supply apparatus may include a program that includes instructions to execute the various embodiments of the present disclosure, a memory that stores information or the like required for the various embodiments of the present disclosure, a communication unit that conducts wired or wireless communication with the electronic apparatus, and a control unit that transmits a corresponding program to a transmission/reception apparatus in response to the request from the electronic apparatus or automatically.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a display unit configured to display an image;
a storage unit configured to store a subtitle display type corresponding to an input event related to the image; and
a controller configured to detect the input event and to control to display subtitles according to the subtitle display type corresponding to the input event.

2. The electronic device of claim 1, wherein the input event includes at least one of a volume change event of changing a volume of a sound corresponding to the image, a size change event of changing a size of the image, a multi-window event of displaying a plurality of images together on the display unit, or a multi-screen event for connecting with an external electronic device through a communication unit over short-range wireless communication.

3. The electronic device of claim 2, wherein the volume change event is an event of turning down the volume of the sound below a preset value and causing the controller to start displaying previously non-displayed subtitles according to the subtitle display type.

4. The electronic device of claim 2, wherein the volume change event is an event of turning up the volume of the sound above a preset value and causing the controller to remove currently displayed subtitles according to the subtitle display type.

5. The electronic device of claim 2, wherein the size change event is an event of making a size of the image larger than a preset size and causing the controller to display subtitles in a position inside the image, rather than outside the image.

6. The electronic device of claim 2, wherein the multi-window event is an event of activating one image of the plurality of images and causing the controller to remove subtitles of an active image, to reproduce a sound of the active image, to display subtitles of an inactive image, or to remove a sound of the inactive image.

7. The electronic device of claim 2, wherein the controller is further configured to control to not overlap a plurality of windows displaying the image on the display unit according to the multi-window event.

8. The electronic device of claim 7, wherein the controller is further configured to control to change a size of a window to be changed according to a window size change command which changes a size of at least one window of the plurality of windows and to reproduce only an image reproduced in the window to be changed when the size of the window to be changed according to the window size change command exceeds a preset threshold size.

9. The electronic device of claim 8, wherein the controller is further configured to control to transmit data about an image displayed in one window selected from the plurality of windows and to transmit data about subtitles corresponding to the displayed image to the external electronic device.

10. The electronic device of claim 8, wherein the controller is further configured to control to transmit data about subtitles corresponding to an image displayed in one window selected from the plurality of windows to the external electronic device.

11. A method of controlling an electronic device, the method comprising:
displaying an image on a display unit of the electronic device;
receiving an input event related to the displayed image;
detecting the input event; and
displaying subtitles corresponding to the image according to a subtitle display type corresponding to the input event.

12. The method of claim 11, wherein the input event includes at least one of a volume change event of changing a volume of a sound corresponding to the image, a size change event of changing a size of the image, a multi-window event of displaying a plurality of images together on the display unit, or a multi-screen event for connecting with an external electronic device through a communication unit over short-range wireless communication.

13. The method of claim 12, wherein the volume change event is an event of turning down the volume of the sound below a preset value and starting a display of previously non-displayed subtitles, according to the subtitle display type.

14. The method of claim 12, wherein the volume change event is an event of turning up the volume of the sound above a preset value and removing currently displayed subtitles, according to the subtitle display type.

15. The method of claim 12, wherein one or more of a size, a brightness, or a color of the subtitles are changed through an adjustor that adjusts the volume of the sound.

16. The method of claim 12, wherein the subtitles are one of stored in a storage unit included in the electronic device in advance or received through the communication unit included in the electronic device.

17. The method of claim 12, wherein the size change event is an event of making a size of the image smaller than a preset size and displaying the subtitles displayed inside the image in one of a position outside the image and a preset position, rather than inside the image.

18. The method of claim 12, wherein the size change event is an event of making a size of the image larger than a preset size and displaying the subtitles in a position inside the image, rather than outside the image.

19. The method of claim 12, wherein the multi-window event is an event of activating one image of the plurality of images, removing subtitles of an active image, reproducing a sound of the active image, displaying subtitles of an inactive image, or removing a sound of the inactive image.

20. The method of claim 12, wherein the subtitle display type corresponding to the multi-screen event is equally executed in real time in the external electronic device through the communication unit.
